(19) United States
(12) Patent Application Publication
(10) Pub. No.: US 2002/0004765 A1
(43) Pub. Date: Jan. 10, 2002

(54) System and method of ordering tag-on purchase using internet

(76) Inventors: Sun Young Han, Seoul (KR); Soo Sang Kim, Seoul (KR); Byung Seon Park, Seoul (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 09/865,434

(22) Filed: May 29, 2001

(30) Foreign Application Priority Data
Jun. 1, 2000 (KR) 2000-29978

(51) Int. Cl. G06F 17/60

(52) U.S. Cl. 705/27

(57) ABSTRACT

A tag-on ordering system and method using the Internet is provided. The tag-on system includes a number of purchaser's terminals, at least one supplier's terminal, and a system server, which are connected to the Internet. In the system server, product information is displayed on a website called a home page when the product information including a minimum supply condition of a supplier's product is received through the supplier's terminal, and a determination of production with respect to a corresponding product is notified to the supplier's terminal, if a total sum of purchasing quantities of respective purchasers requested via the purchaser's terminal meet the minimum supply condition of the supplier, when the respective purchasers request for the respective purchasing quantities each of which fails the minimum supply condition on the home page.

### BACKGROUND OF THE INVENTION

1. Field of the Invention

The present invention relates to a tag-on ordering system and method using the Internet, and more particularly, to a tag-on ordering system and method in which purchasing quantities from a number of purchasers who wish to purchase a small amount of fabrics are summed together, in the case of an order-based product such as textile fabrics which are produced only by a bulk order, and it is determined to produce a total sum of the purchasing quantities, with respect to the order-based product., in the case that the total sum of the purchasing quantities is not less than a predetermined quantity.

2. Description of the Related Art

In general, a product transaction on an electronic commerce is performed through a typical procedure as shown in FIG. 5.

Referring to FIG. 5, a purchaser accesses an electronic commerce website using a computer in which a web browser is mounted (S41), and then selects a product to be purchased (S42).

If a purchaser selects a product, additional information with respect to the selected product is displayed on a computer display and a purchasing procedure is also guided.

If a purchaser requests for a sample instead of purchasing a product (S421), a purchaser's computer transfers a sample request page to a seller, using an electronic mail (S422).

Meanwhile, if a purchaser desires to purchase a produce, a list on a cart is ascertained (S43), and then a purchasing product is selected from the cart (S44). If a purchasing order is requested for (S45), a purchaser's computer transfers a purchasing request page to a seller, using an electronic mail (S46).

Also, if a purchaser pays for a purchased product or sample, using an electronic money or a credit card (S47), a seller ascertains the payment (S48) and delivers the corresponding product or sample to the purchaser (S49).

The above-described electronic commerce is an electronic commerce with respect to a general product which is produced according to a certain individual specification, but is not appropriate for an electronic commerce of textile fabrics for making cloths which are produced only in the case of a certain quantity of massive purchasing orders as in the present invention. The reasons will be described below.

Generally, textile fabrics are classified into various kinds according to materials, weaving types, and design patterns of the fabrics.

The textile fabrics are fabricated by weaving original gossamers made of materials such as cotton, synthetic textile, silk or wool, single or in combination thereof. There are a number of textile fabrics according to the kind of materials, weaving technologies, fabrication methods. The namer of textile fabrics is determined by the kind of original gossamers, weaving technologies, or uses. Representative brand names are used as those of the textile fabrics. Such representative textile fabrics are polyester, nylon, cotton, silk, wool, spandex, velvet, tricot, circular knit, lace, leather, jacquard, man-made suede, etc.

Meanwhile, it is principle to produce textile fabrics after the kind of textile fabrics and a production quantity thereof have been determined. By the way, in view of a textile fabrics production company which produces textile fabrics, a cost efficiency consumed for preparing and processing production of textile fabrics greatly varies depending upon the production quantity in size. As a result, textile fabrics production companies cannot help producing fabrics only in the case of ordering quantities over a profit and loss balance point with respect to textile fabrics to be produced in order to produce a kind of textile fabrics.

Further, the capacity of the production facility in most of textile fabrics production companies is very large scaled and thus cannot meet most of small quantity based purchasing orders, although the profit and loss balance matter is not considered.

In other words, a large company which can order a massive amount of fabrics can meet a minimum production quantity of a textile fabrics production maker only with its own ordering quantity. Accordingly, the large company does not need to order an excessive quantity in order to secure a basic textile fabrics quantity. The quantity of the fabrics necessary for making cloths is smaller than the minimum production quantity of the fabrics production maker, in the case of a small company or even a large company which needs textile fabrics which are used only for a small part of cloths. Thus, only a quantity of one order cannot meet the minimum production quantity of the fabrics production maker in most cases.

In the case that a small quantity of fabrics is necessary, a plurality of companies of the same kind can order a textile fabrics production whose quantities are negotiated among the companies. However, since a textile fabrics production process requires more than a minimum production quantity, unnecessarily ordered and remaining textile fabrics should be sold at a cheap price. As a result, the companies which need a small quantity of textile fabrics have purchased the fabrics at an unnecessarily high cost.

Thus, a small scale clothing company cannot but purchase textile fabrics which are produced in a textile fabrics production maker and sold on a small quantity basis, and manufacture only clothing matching the purchased textile fabrics. Otherwise, the small scale clothing company obtains information by inquiry on a textile fabrics production schedule of textile fabrics production maker, and then requests an order on an additional basis in the case that the textile fabrics to be produced are close to desired textile fabrics, which is a general custom to produce clothing in the small clothing company.

However, since the kind of the textile fabrics, the processing technologies, tones, and designs are very diverse in most cases, such an additional purchasing order is possible theoretically but is not adopted in practice.

In particular, even a textile fabrics production maker does not produce textile fabrics in the case of a small quantity production or a particular structure. Accordingly, the clothing company is very difficult to secure the textile fabrics for manufacturing clothing. As a result, the small clothing company obtains information on textile fabrics production makers by inquiry from worldwide textile fabrics production markets, or should withdraw a new clothing manufacturing schedule in the case of securing no textile fabrics.

In the case of an existing textile fabrics supply market, a textile fabrics demand and supply quantity is not consistent between a textile fabrics supply maker producing and supplying textile fabrics and a clothing company manufacturing clothing using the textile fabrics. As a result, the textile fabrics production maker has the difficulty in securing a quantity of textile fabrics continuously, and the clothing manufacturing company has not be supplied textile fabrics of a desired pattern and quantity in time from the textile fabrics production maker. Thus, there have been loss problems in view of time and cost between the textile fabrics production maker and the clothing manufacturing company.

### SUMMARY OF THE INVENTION

To solve the above problems, it is an object of the present invention to provide a tag-on ordering system and method using the Internet, in which purchasing quantities of a plurality of companies which desire to purchase textile fabrics on a small quantity basis are summed together when a product such as textile fabrics is produced by a series of processes and in the case that a current production quantity is in short of a minimum production quantity, in order to meet a minimum quantity purchasing condition, to thereby enable the textile fabrics production maker to produce the product such as the textile fabrics, and secure a more quantity of production, and to thereby enable the manufacturing company producing a secondary product such as clothing from a primary product such as textile fabrics to purchase a proper and small quantity of primary textile fabrics in desired time.

To accomplish the above object of the present invention, there is provided a tag-on ordering system using the Internet for use in a product ordering system which determines to produce a product only in the case that a minimum production quantity is secured, the tag-on ordering system comprising: a number of purchaser's terminals, each of which is used for a respective purchaser is connected to the Internet, in which a web browser is mounted to enable a purchaser to purchase products on an on-line basis; at least one supplier's terminal, each of which is used for a supplier is connected to the Internet to enable the supplier to supply products to a purchaser, in which a web browser is mounted; and a system server which is connected to the Internet, in which product information is displayed on a website called a home page when the product information including a minimum supply condition of a supplier's product is received through the supplier's terminal, and a determination of production with respect to a corresponding product is notified to the supplier's terminal, if a total sum of purchasing quantities of respective purchasers requested via the purchaser's terminal meet the minimum supply condition of the supplier, when the respective purchasers request for the respective purchasing quantities each of which fails the minimum supply condition on the home page.

According to another aspect of the present invention, there is also provided a tag-on ordering method using the Internet for use in a product ordering method whose production is determined only in the case that a minimum production quantity is secured, the tag-on ordering method comprising the steps of: (a) registering product information including a minimum supply condition of a product which can be supplied from at least one supplier on a website called a home page in a system server; (b) receiving an order with respect to each registered product until a determined order receiving due date; (c) comparing a total purchasing quantity of purchasing orders with respect to each registered product with a minimum supply quantity in the minimum supply condition registered by the supplier; and (d) giving up production or extending the order receiving due date if the total sum of ordered quantities with respect to each product is smaller than the minimum supply quantity, or producing and delivering the product to each purchaser if the former is larger than the latter.

As described above, the present invention enables even a purchaser who needs only a small quantity to easily purchase a product such as textile fabrics which is produced only in the case that a production quantity is larger than a minimum production quantity or a quantity over a profit and loss balance point.

### BRIEF DESCRIPTION OF THE DRAWINGS

The above object and other advantages of the present invention will become more apparent by describing the preferred embodiment thereof in more detail with reference to the accompanying drawings in which:

FIG. 1 shows a configuration of a tag-on ordering system using the Internet according to the present invention;

FIG. 2 is a flowchart view for explaining a tag-on ordering method using the Internet according to the present invention;

FIG. 3 is an exemplary view showing a bulk tag-on purchase in the present invention;

FIG. 4 is an exemplary view showing a team up bulk tag-on purchase in the present invention; and

FIG. 5 is a flowchart view for explaining an existing electronic commerce method.

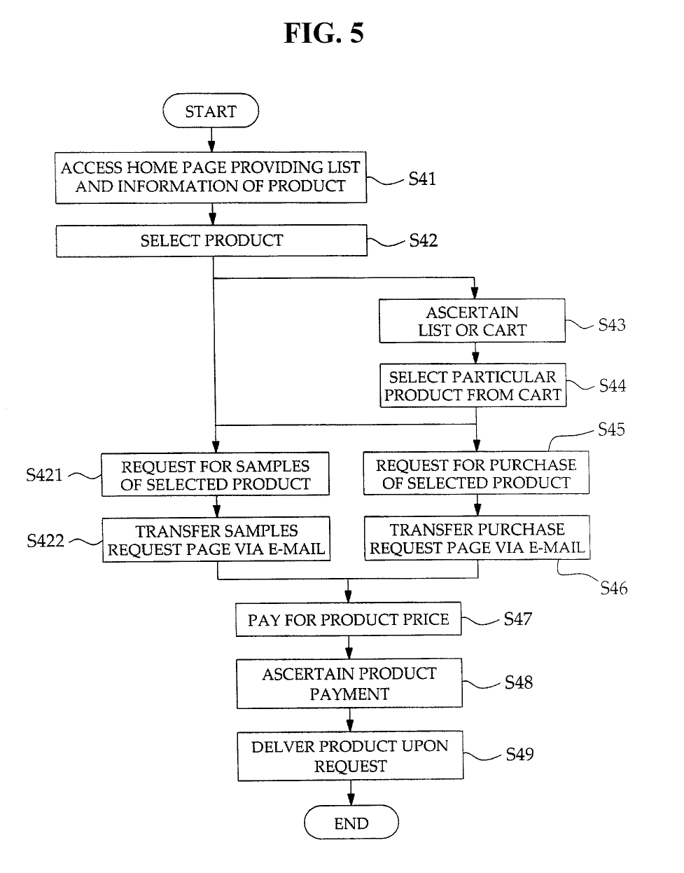

### DETAILED DESCRIPTION OF THE INVENTION

A preferred embodiment of the present invention will be described with reference to the accompanying drawings.

A tag-on ordering system using the Internet according to the present invention is an ordering and selling system for a product such as textile fabrics which are produced only when a production quantity is over a minimum production quantity basis.

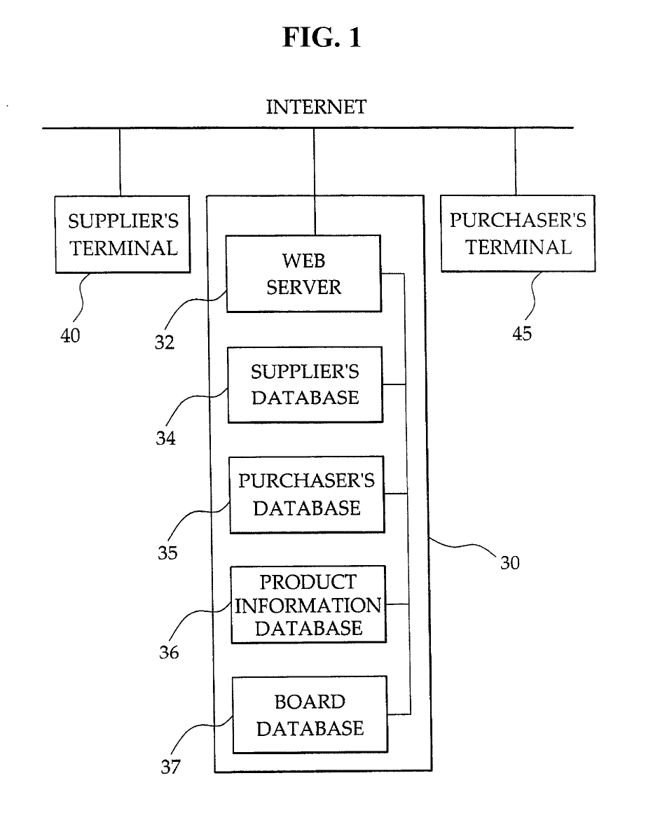

Referring to FIG. 1, a tag-on ordering system according to the present invention includes a number of purchaser's terminals 45, at least one supplier's terminal 40, and a system server 30. The purchaser's terminal 45 which is used for a respective purchaser is connected to the Internet, in which a web browser is mounted to enable a purchaser to purchase products on an on-line basis. The supplier's terminal 40 which is used for a supplier is connected to the Internet to enable the supplier to supply products to a purchaser, in which a web browser is mounted. The system server 30 is connected to the Internet, in which product information is displayed on a website called a home page when the product information including a minimum supply condition of a supplier's product is received through the supplier's terminal, and a determination of production with respect to a corresponding product is notified to the supplier's terminal 45, if a total sum of purchasing quantities of respective purchasers requested via the purchaser's terminal 45 meet the minimum supply condition of the supplier, when the respective purchasers request for the respective purchasing quantities each of which fails the minimum supply condition on the home page.

The system server 30 includes a supplier's database (DB) 34 storing registration information of a supplier producing and delivering a product, a purchaser's DB 35 storing registration information of a purchaser who desires to purchase a product, a product information DB 36 storing product information of the product supplied from the supplier, a home page DB 37 storing home page data and board information necessary for running the system server 30, and a web server 32 for managing data of each DB, enabling supplying and purchasing activities of the supplier and purchaser, and managing an Internet connection of the system server 30.

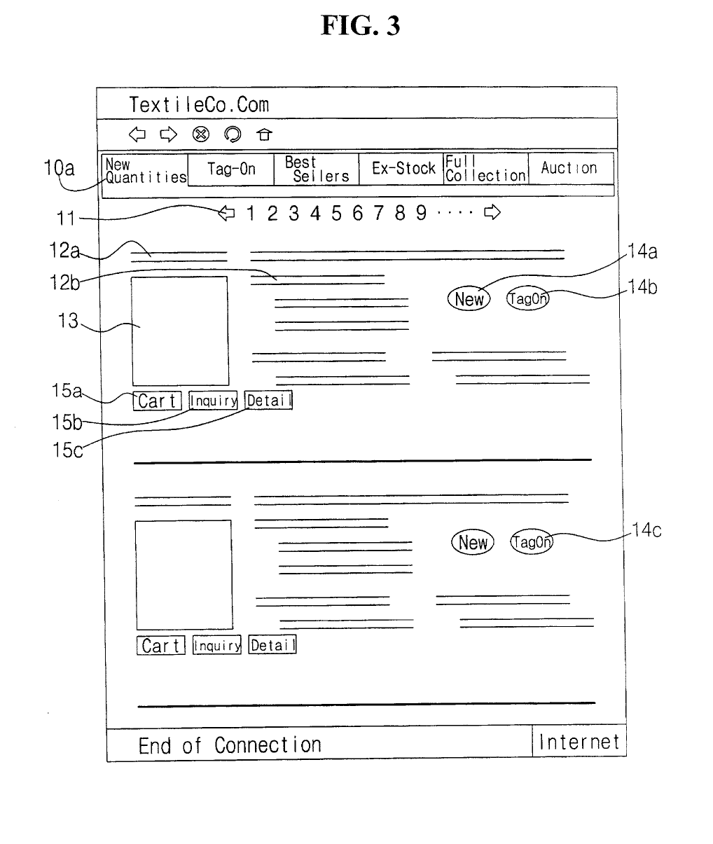

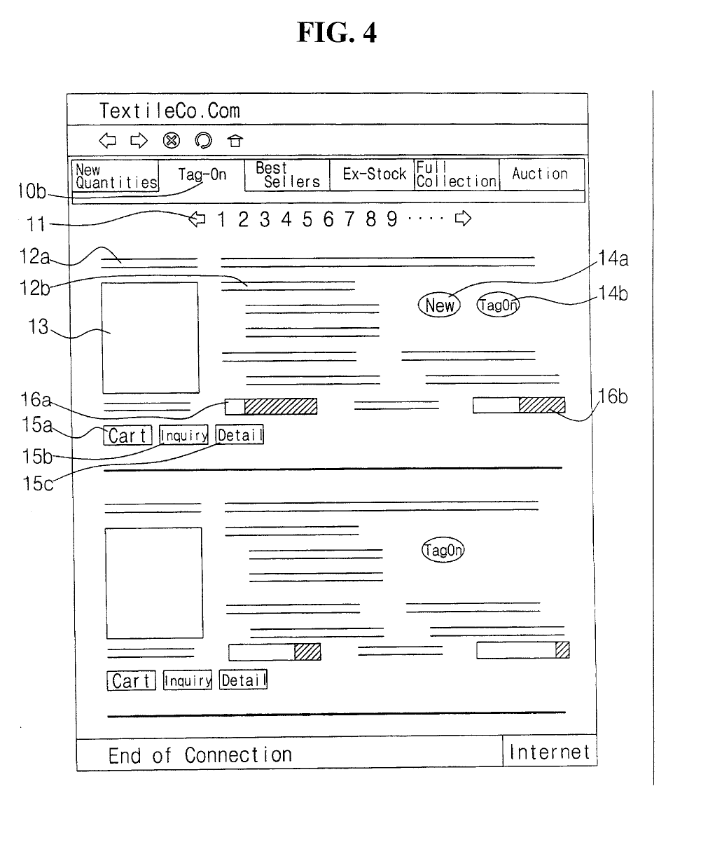

As described above, the system server 30 receives supply product information registered by a supplier via a supplier's terminal 40, and then displays the received supply product information in the form as shown in FIGS. 3 and 4, to thereby enable a purchaser to access the home page via the purchaser's terminal and perform a purchasing activity of a desired product.

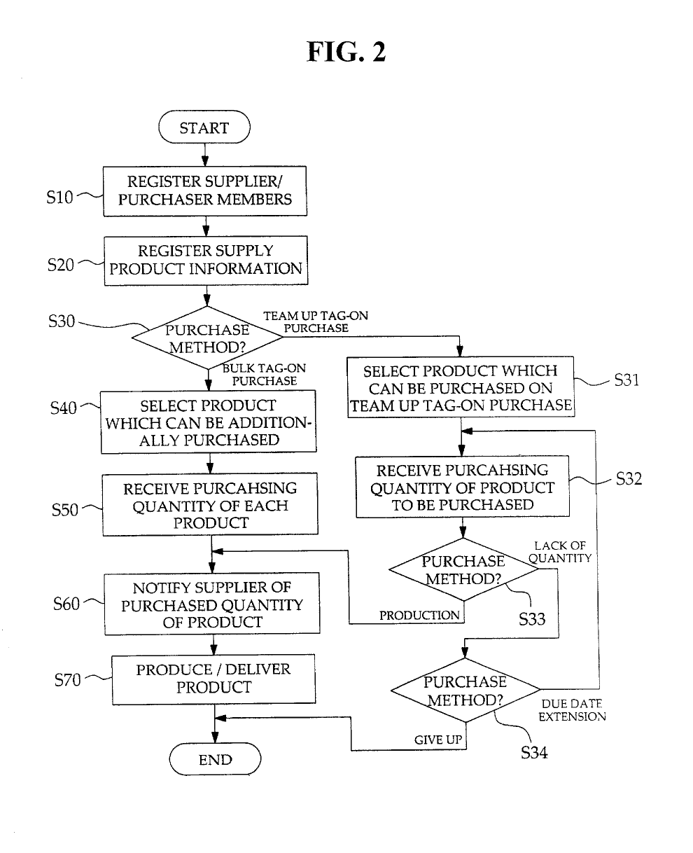

The operation of the tag-on ordering system using the Internet according to the present invention having the above configuration will be described below with reference to FIG. 2.

First, a supplier producing and delivering a product and a purchaser purchasing a product supplied from the supplier register on a website called a home page via a supplier's terminal 40 and a purchaser's terminal 45, respectively (S10). Here, the supplier includes a manufacture which produces a product, and a seller which receives and sells the product from the manufacturer, and the purchaser includes an intermediate seller which purchases the product and resells the purchased product, a processor which purchases and processes the product and sells the processed product, and a clothing manufacturer which purchases the product and manufactures and sells the clothing.

The information registered as a member is stored and managed in the supplier's DB 34 and the purchaser's DB 35. The information with respect to the product supplied from the supplier is registered in the product information DB 36 and managed (S20).

Here, the product information registered in the 5 product information DB 36 includes a product name, a product image, a supplier, the place of origin, a constituent, a color, a use, a usable season, a width, a weight, a price, and remarks, in which a product code is assigned with respect to each product and the product code functions as a key, as illustrated in the following Table 1.

TABLE 1

| | |
|---|---|
| Product code | 0001 |
| Product name | 100% Rayon Twill Print |
| Product image | 0001.jpg |
| Supplier | Sunwoo Inc. |
| Place of origin | Republic of Korea |
| Ingredient | Rayon 100% |
| Color | Brown |
| Use | Dress |
| Usable season | Autumn |
| Width | 54/55″ |
| Weight | 260 g/L′yard(205 g/Sqm |
| Price | US$2.00/Yd |
| Remarks | Screen Printed |

The product information in Table 1 has been described with an example of textile fabrics. However, the present invention can be also applied to cases of re-setting a production line made of a number of processes and temporarily producing a certain particular model product such as various mechanical products, electronic products and chemical products, as in the case of the textile product such as the textile fabrics.

In the case of the textile fabrics, the product information further includes a color of the textile fabrics, a minimum purchasing quantity, a purchase receiving due date, and so on, in addition to the above information in Table 1.

The information such as the minimum purchasing quantity and the purchase receiving due date is crucial information which is based on a judgment whether a small quantity based order is received and cumulated until the purchase receiving due date from each purchaser who orders a small quantity of products, and the totally cumulated quantity is compared with the minimum production quantity being a reference condition by which the product is produced.

Meanwhile, the purchaser accesses the system server 30 in order to purchase a product and selects one between an additional purchase or a summation purchase (S30). According to the selected purchase method, the desired product is purchased, whose purchase method procedure will be described below.

Here, when a purchaser “A” has requested for purchase of the product more than a minimum purchasing quantity of for example textile fabrics, the additional purchase means that another purchaser additionally purchases the product whose production is determined by a supplier, in which the supplier additionally produces the product and delivers the product to the additional purchaser.

In the case that a purchasing quantity of each purchaser is in short of a minimum production quantity from which a supplier can determined to produce a product, the summation purchase means that a purchasing quantity of each purchaser is summed and the product is produced and delivered to each purchaser when the summed quantity is not less than the minimum production quantity by which the supplier can determined to produce the product.

In the present invention, the additional purchase and the summation purchase are defined as a tag-on purchase, in which the additional purchase has been defined as a bulk tag-on purchase and the summation purchase has been defined as a team up tag-on purchase.

If a purchaser selects a bulk tag-on purchase, the system server 30 displays a product which can be additionally purchased to enable purchasers to select it, thereby making the purchasers select the product (S40).

After the purchaser has selected a product to be purchased (S40), a purchasing quantity of the product to be purchased is input to enable the system server 30 to receive the purchasing quantity (S50).

The system server 30 receives the purchasing quantity from the purchaser and notifies the purchasing quantity to the supplier (S60).

The supplier investigates the purchasing quantity of each product and produces and delivers the product (S70).

Meanwhile, if a purchaser selects a team up tag-on purchase, the system server 30 displays a product which can be purchased in sum to enable purchasers to select it, thereby making the purchasers select the product (S31).

Here, when a product which can be purchased on a team up tag-on purchase basis is displayed, a purchase receiving due date is also displayed.

The system server 30 receives purchasing quantities from a number of purchasers until the purchase receiving due date of each product (S32), and judges whether or not a total sum of the received purchasing quantities is larger than the minimum supply quantity determined by the supplier (S33).

If the total sum of the received purchasing quantities is larger than the minimum supply quantity determined by the supplier in the result of the judgment of the purchasing quantity, the system server 30 determines to produce the product and notifies the product purchasing quantity to the supplier (S60) to make the supplier produce and deliver the product (S70).

By the way, if the total sum of the received purchasing quantities is smaller than the minimum supply quantity determined by the supplier in the result of the judgment of the purchasing quantity, the system server 30 determines whether or not a purchase receiving due date is extended (S34) to then receive a further purchase or give up a production of the product.

Also, the system according to the present invention enables a new dealing in addition to the additional purchase and the summation purchase with respect to the existing dealing as described above, which will be described with reference to FIG. 3 as an exemplary screen. For new purchases, a menu named by “New quantities” 10a on the screen of FIG. 3 should be selected.

In the case that there are a number of registered products, the registered products cannot be displayed on a single screen. Accordingly, a page number and left and right shift arrows 11 are displayed to shift a current page to the previous and following page, respectively.

Also, a product name 12a, a product image 13 and a product description 12b of each product are displayed.

It is indicated as a menu “New” 14a or “TagOn” 14b in FIG. 3 whether a corresponding product can be purchased on a new purchase basis 14a or on a tag-on purchase basis 14b. Here, in the case that a stock 14c of a product exists, the stock is indicated as a menu “Stock” 14c in FIG. 3.

A purchase according to a purchasing determination is performed by clicking a menu “Cart” 15a, an inquiry with respect to a product is performed by clicking a menu “Inquiry” 15b, and an enlargement of the product image 13 is performed by clicking a menu “Detail” 15c.

An exemplary screen shown in FIG. 4 is a screen for a tag-on dealing, whose indications are same as those of FIG. 3. In FIG. 4, received purchase quantity indication bars 16a and 16b are further included differently from that of FIG. 3.

A purchase receiving due date for closing an ordering is indicated on the new purchase or tag-on purchase.

Thus, a purchaser sees the received purchase quantity indication bars 16a and 16b and can judge that his or her tag-on purchase can be produced in the case that the received purchase quantity exceeds the minimum production quantity on the purchase receiving due date.

The embodiment has been described with respect to the example of textile fabrics of clothing. However, it is apparent to one who has an ordinary skill in the art that the present invention can be applied to products which can be produced only in the case that a basic production quantity is larger than a minimum production quantity as in clothing fabrics.

As described above, the tag-on ordering system and method using the Internet according to the present invention provides an effect of enabling purchasers who wish to purchase a product on a minimum production quantity or less basis to purchase the product which can be produced only in the case that the purchasing order quantity is larger than the minimum production quantity.

As described above, the present invention has been described with respect to the particularly preferred embodiment. However, the present invention is not limited in the above-described embodiment. It is apparent to one who is skilled in the art that there are many variations and modifications, within the technical scope of the appended claims without departing off the spirit of the present invention.

What is claimed is:

1. A tag-on ordering system using the Internet for use in a product ordering system which determines to produce a product only in the case that a minimum production quantity is secured, the tag-on ordering system comprising:
a number of purchaser's terminals, each of which is used for a respective purchaser is connected to the Internet, in which a web browser is mounted to enable a purchaser to purchase products on an on-line basis;
at least one supplier's terminal, each of which is used for a supplier is connected to the Internet to enable the supplier to supply products to a purchaser, in which a web browser is mounted; and
a system server which is connected to the Internet, in which product information is displayed on a website called a home page when the product information including a minimum supply condition of a supplier's product is received through the supplier's terminal, and a determination of production with respect to a corresponding product is notified to the supplier's terminal, if a total sum of purchasing quantities of respective purchasers requested via the purchaser's terminal meet the minimum supply condition of the supplier, when the respective purchasers request for the respective purchasing quantities each of which fails the minimum supply condition on the home page.

2. The tag-on ordering system using the Internet of claim 1, wherein said system server comprises:
a supplier's database (DB) storing registration information of a supplier producing and delivering a product;
a purchaser's DB storing registration information of a purchaser who desires to purchase a product;
a product information DB storing product information of the product supplied from the supplier;
a home page DB storing home page data and board information necessary for running the system server 30; and
a web server for managing data of each DB, enabling supplying and purchasing activities of the supplier and purchaser, and managing an Internet connection of the system server.

3. The tag-on ordering system using the Internet of claim 1, wherein said system server substitutes the function of the supplier's terminal in the case that the system server operator receives an order from each purchaser and produces and delivers the product.

4. A tag-on ordering method using the Internet for use in a product ordering method whose production is determined only in the case that a minimum production quantity is secured, the tag-on ordering method comprising the steps of:
(a) registering product information including a minimum supply condition of a product which can be supplied from at least one supplier on a website called a home page in a system server;
(b) receiving an order with respect to each registered product until a determined order receiving due date;
(c) comparing a total purchasing quantity of purchasing orders with respect to each registered product with a minimum supply quantity in the minimum supply condition registered by the supplier; and
(d) giving up production or extending the order receiving due date if the total sum of ordered quantities with respect to each product is smaller than the minimum supply quantity, or producing and delivering the product to each purchaser if the former is larger than the latter.

5. The tag-on ordering method using the Internet of claim 4, wherein said step (c) of comparing the total ordered quantity of each purchaser wit the supplier's minimum supply quantity, further comprises the steps of judging whether an additional order is received from other purchasers and the product is additionally produced and delivered, in the case that the purchased quantity exceeds the minimum production quantity of the supplier.

6. The tag-on ordering method using the Internet of claim 4, wherein at the step (a) of registering the product information, said product information comprises a product name, a product image, a supplier, the place of origin, a constituent, a color, a use, a specification, a price, and a minimum production quantity, and an order receiving due date.
